(19) United States
(12) Patent Application Publication
(10) Pub. No.: US 2015/0324713 A1
(43) Pub. Date: Nov. 12, 2015

(54) AUTOMATED DESIGN OF INFORMATION TECHNOLOGY SERVICE SOLUTIONS

(71) Applicant: International Business Machines Corporation, Armonk, NY (US)

(72) Inventors: Richard M. Haas, Wellesley, MA (US); Randy S. Johnson, O'Fallon, MO (US); Tedrick N. Northway, Wood River, IL (US); Homer W. Rinckel, Prospect, CT (US)

(73) Assignee: International Business Machines Corporation, Armonk, NY (US)

(21) Appl. No.: 14/270,646

(22) Filed: May 6, 2014

(51) Int. Cl. G06Q 10/06; H04L 29/06

(52) U.S. Cl. CPC G06Q 10/0633; G06Q 10/067; H04L 67/42

(57) ABSTRACT

A computer implemented method for automated design of information technology solutions. In an embodiment, the method comprises identifying a client for whom the service solution is being provided, and an applicable technology domain associated with the client; identifying a market segment associated with the client; generating a market-based profile for the client, the market-based profile derived, at least in part, from the identified market segment and the applicable technology domain; retrieving applicable workload profiles for the client, wherein the applicable workload profiles are retrieved, at least in part, by mapping the generated market-based profile for the client to a plurality of workload profiles; and generating a prototype solution, based, at least in part, on alignment of the applicable workload profiles to the market-based profile for the client. The method further includes customizing the prototype solution to provide a solution that includes client-unique specification of service solution parameters.

### FIELD OF THE INVENTION

The present invention relates generally to providing information technology solutions that meet client expectations, and in particular to the application of both business and technology insight in the creation and execution of client solutions.

### BACKGROUND OF THE INVENTION

Providing service solutions to customers is a very wide-ranging and diverse enterprise. The scope of information technology (IT) service solutions can range from a single software program running on a single client device to complex application software distributed across multiple hosts. Some clients demand turnkey systems, such as a bank desiring a complete accounting package. Other clients simply wish to have a service solution provided and maintained on their behalf, such as a client desiring complete data centers operating at a specified service level.

In identifying a solution in the data center space, it is at least necessary to determine appropriate computing power, storage requirements, and network capacity to support such a service offering. It is conceivable that a client could have terabytes of data in diverse locations, but nonetheless wants data storage and delivery at high transaction speed. Effective service solution providers spend considerable time attempting to optimize solutions for client requirements such as these.

In some cases, cloud computing may provide the answer for solutions requiring extraordinary computing resources. The term “cloud computing” generally characterizes a computing environment where a substantial number of computers are interconnected over a large data network, such as the Internet. This is an ideal environment for network-based services, and many business entities take advantage of this arrangement to avail themselves of “software as a service,” or SaaS, in which software applications and data are hosted by a remotely-located computer (or group of computers) accessible over the Internet.

Some clients are interested in acquiring business process services only. One fairly popular service solution is this space is CRM, or customer relationship management. CRM can automate the collection and analysis of vast amounts of data relating to the interactions between a company and their customers. This approach has proven effective in promoting process efficiency and customer retention. For a large client, CRM may utilize a large amount of computing resources and network capacity, hence the interest in “outsourcing” this type of operation.

### SUMMARY

Embodiments in accordance with the present invention disclose a computer implemented method, computer program product, and system for automated design of information technology solutions. A method in accordance with the present invention comprises identifying, by one or more processors, a client for whom the service solution is being provided, and an applicable technology domain associated with the client; identifying, by one or more processors, a market segment associated with the client; generating, by one or more processors, a market-based profile for the client, the market-based profile derived, at least in part, from the identified market segment and the applicable technology domain; retrieving, by one or more processors, applicable workload profiles for the client, wherein the applicable workload profiles are retrieved, at least in part, by mapping the generated market-based profile for the client to a plurality of workload profiles; and generating, by one or more processors, a prototype solution, based, at least in part, on alignment of the applicable workload profiles to the market-based profile for the client, wherein the prototype solution addresses common market requirements for the client's specific market. The method further includes customizing, by one or more processors, the prototype solution, based, at least in part, upon specific client requirements, to provide a solution that includes client-unique specification of service solution parameters.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a representation of several types of workload profiles and associated specifications in accordance with an embodiment of the present invention.

FIG. 3 is a flowchart depicting development of a workload profile in accordance with an embodiment of the present invention.

FIG. 4 is a flowchart of steps involved in creating a market-based profile in accordance with an embodiment of the present invention.

FIG. 5 is a representation of a portion of a market-based profile for storage, for the healthcare and life sciences industry, in accordance with an embodiment of the present invention.

FIG. 6 is a flowchart of steps involved in building and tailoring a client solution in accordance with an embodiment of the present invention.

FIG. 7 is a functional block diagram of a computer system in accordance with an embodiment of the present invention.

### DETAILED DESCRIPTION

As IT capabilities continue to evolve, client expectations have generally grown from a focus on “point solutions,” targeted at discrete elements of an IT environment with performance judged through IT results, to a more sophisticated cross-IT view aligned to business impact utilizing a foundation based on business outcomes. To successfully address this trend, IT service providers seek to apply both business and technology insight in the creation and execution of client solutions. A system designed to generate a services solution that is both compelling to clients and reflective of the market environment, such as the system described herein, includes several features.

First, the solution should be IT-specific. In other words, an observable degree of commonality exists across client environments with respect to specific IT tasks and activities. Secondly, the solution should be market-specific. This means that exogenous factors driving common practices (e.g., regulations, etc.), and/or dynamics inherent in a particular market segment, impact performance requirements and methods of operation. Incorporation of market-specific characteristics and patterns into a system allows solutions to reflect salient characteristics, drawn from market insight. In addition, the solution should be client-specific. The solution should take into account capabilities that reflect an individual client's environment to meet discrete business objectives, often performed through unique activities, operations, and/or performance requirements.

The system described herein for automated design of service solutions effectively balances the three features described above by 1) aggregating IT-specific tasks into “workload profiles,” 2) defining “market-based profiles” and decomposing these profiles into assemblages of “workload profiles,” and 3) incorporating the appropriate level of flexibility to alter both the mix of workload profiles for a particular client, and individual parameters that are often unique for clients (e.g., size of storage environment, etc.). The process of solution creation is automated by using discrete operational characteristics, with insight gleaned from engagement experience and technical delivery expertise, and an understanding of associated volumes (typically represented as number of images, gigabytes or GB of storage, etc.). A system is then assembled that enables configuration of services to meet client requirements through information on high-level specifications of a solution, together with workload and market-based profiles that capture the service solution provider's IT and business insight, respectively.

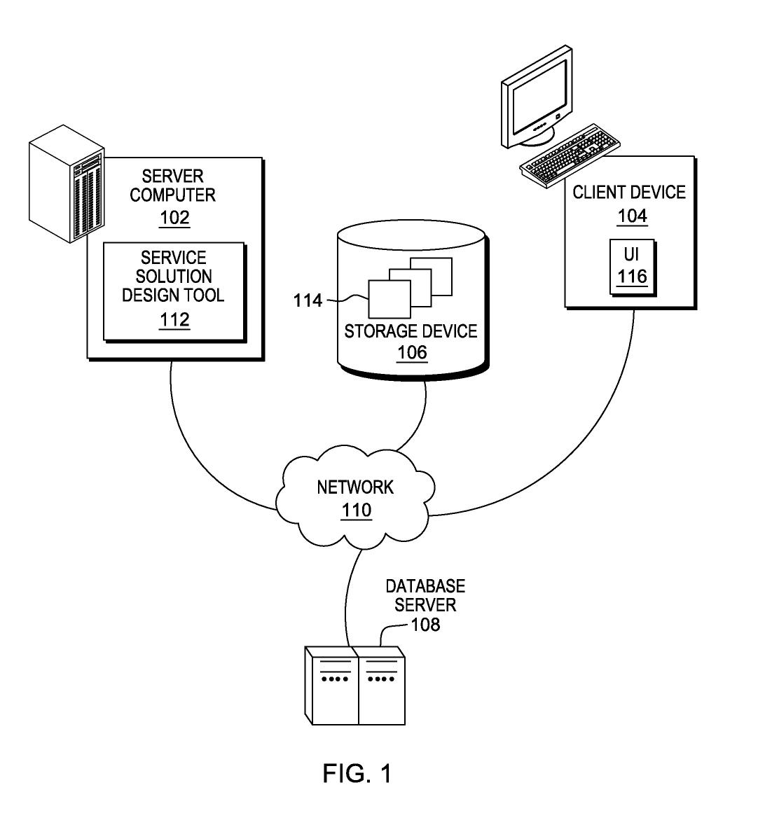

The present invention will now be described in detail with reference to the Figures. FIG. 1 is a functional block diagram illustrating a distributed data processing environment, in accordance with one embodiment of the present invention. The distributed data processing environment includes server computer 102, client device 104, storage device 106, and database server 108 interconnected over network 110.

Server computer 102 may be a desktop computer, a laptop computer, a tablet computer, a specialized computer server, a smartphone, or any other computer system known in the art. In certain embodiments, server computer 102 represents a computer system utilizing clustered computers and components that act as a single pool of seamless resources when accessed through network 110, as is common in data centers and with cloud computing applications. In general, server computer 102 is representative of any programmable electronic device or combination of programmable electronic devices capable of executing machine-readable program instructions and communicating with other computer devices via a network. In this embodiment, server computer 102 has the ability to communicate with other computer devices to query the computer devices for information.

Service solution design tool 112 residing in server computer 102 has the ability to access multiple data files or databases 114 stored in multiple storage locations within storage device 106. Data files and databases 114 contain content upon which service solution design tool 112 operates, as does database server 108. In various embodiments of the present invention, database server 108 can be a server computer, a database, a storage device, or any programmable device capable of communicating with server computer 102, client device 104, and storage device 106 via network 110. In various embodiments, a user of client device 104 may utilize user interface 116 to monitor operation and view results from service solution design tool 112. In an embodiment, client device 104 may actually host service solution design tool 112.

In general, network 110 can be any combination of connections and protocols that will support communications between server computer 102, client device 104, storage device 106, and database server 108. Network 110 can include, for example, a local area network (LAN), a wide area network (WAN) such as the internet, a cellular network, or any combination of the preceding, and can further include wired, wireless, and/or fiber optic connections.

In one embodiment, service solution design tool 112 may be a web service accessible via network 110 to a user of a separate device, e.g., client device 104. In another embodiment, service solution design tool 112 may be operated directly by a user of server computer 102. One of the hurdles that must be cleared in distributed computing environments is the fact that data formats may be unique to particular applications, and consequently incompatible with others. Thus, behind the scenes of distributed computing, there is an ongoing effort to overcome compatibility issues through application integration. In enterprise environments, achieving operational harmony among disparate applications and data formats is often accomplished through “middleware.”

In simple terms, middleware is computer software that resides between the operating system for a particular platform and application software providing desirable functionality. Middleware's primary purposes are facilitating communication and input/output (I/O) operations among applications. Since the above-cited incompatibilities among disparate data structures are regularly encountered outside the enterprise setting, even in client-server operations, enabling proper communication and I/O is a task toward which a great deal of development work has been directed.

User interface 116 on client device 104 displays information that service solution design tool 112 may display to a user. User interface 116 can be, for example, a graphical user interface (GUI) or a web user interface (WUI) and can display text, documents, web browser windows, user options, application interfaces and instructions for operation. In various embodiments of the present invention, client device 104 can be a laptop computer, a tablet computer, a netbook computer, a personal computer (PC), a desktop computer, a personal digital assistant (PDA), a smartphone, or any programmable electronic device capable of communicating with server computer 102, storage device 106, and service solution design tool 112 via network 110.

It is helpful for providers who develop optimized service solutions to utilize an assessment that provides early insight into a client's current operational environment, as well as the potential maturity of the future target operational environment. In an example based upon a potential storage system solution, as shown in Table I below, the assessment evaluates a limited number of technical dimensions that represent the high-level specifications of a services solution or operational environment to identify areas where firms can drive improved performance.

TABLE I
Potential High-Level Specifications of a Solution for a Storage Environment

| | |
|---|---|
| a | Standardization and optimization of storage products |
| b | Tiering optimization |
| c | Optimization of infrastructure used for backup |
| d | Storage virtualization |
| e | Thin provisioning |
| f | Data de-duplication (online/offline) |
| g | Converged storage network |
| h | Replication and data movement with minimal impact to client network |
| i | Optimization of backup performance and disaster recovery |
| j | Ability to manage massive and widely distributed environments |
| k | Standardization/automation/analytics |
| l | Global Delivery Framework model |
| m | Addressing out of control storage growth (software and processes) |
| n | Cloud/storage on demand |
| o | Software to address general counsel needs |
| p | Software to manage data security and encryption issues |
| q | Energy efficient data centers |

For example, specification “a” from Table I relates to standardization and optimization of storage products. In other words, the provider should determine whether the potential customer wishes to restrict the hardware and software involved in the storage environment to a particular vendor or particular architecture. This is an important factor in providing the appropriate solution for the customer, as are all of the specification items listed in Table I.

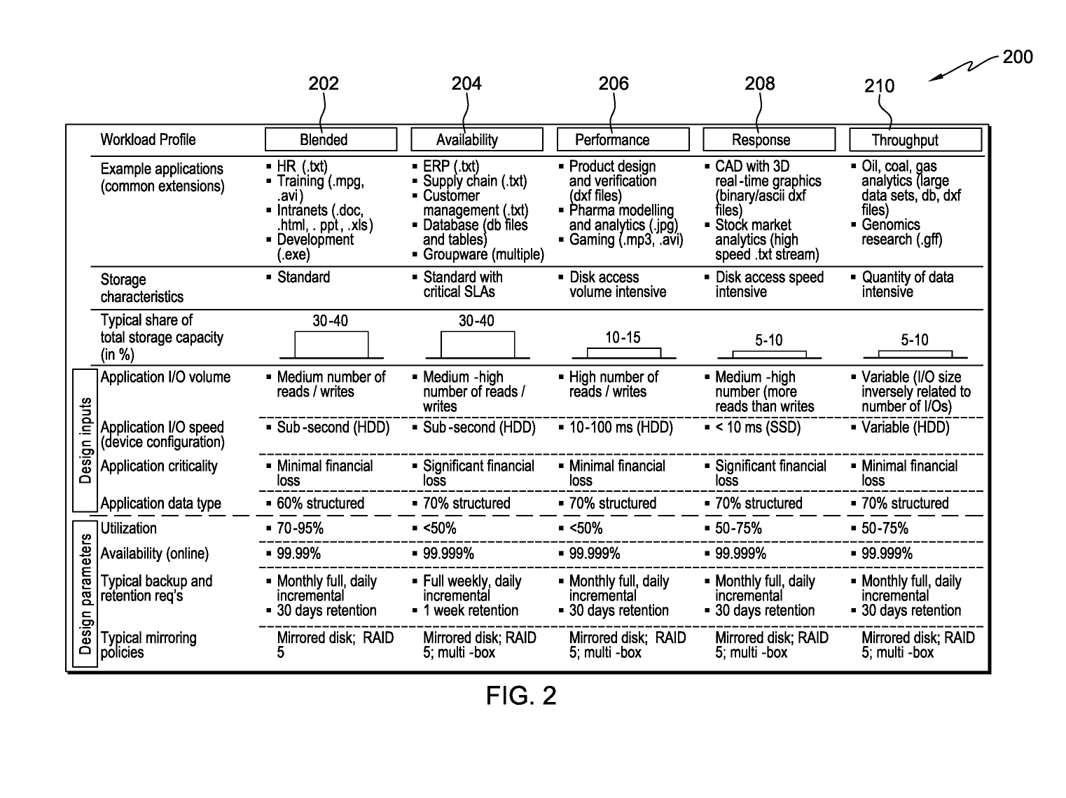

FIG. 2 is a representation, generally depicted by the numeral 200, of several types of workload profiles and associated specifications in accordance with an embodiment of the present invention. Workload profiles generally represent industry-agnostic specifications for hardware, software, and services that deliver specific performance characteristics in a certain technology environment. For example, a storage environment that requires fast response times, low latency, and is disk-access intensive could be described by a “Response” workload profile, as illustrated in Response column 208. For differing types of workloads, a workload profile is a useful tool. Many of the specifications of a services solution or operating environment (described above) may be embedded within the workload profiles, such that usage of a particular workload profile entails a pre-set value for the solution specifications.

In the embodiment illustrated in FIG. 2, there are five workload profiles identified. Each workload profile has unique performance characteristics with defined IT results, and incorporates a common set of IT specifications that are tuned a priori to achieve defined levels of performance. The “Blended” workload profile in column 202 depicts standard performance characteristics that deliver generally undifferentiated capabilities. These may include, for example, without limitation, IT in support of HR (human resources) activities such as training, or in support of the development and test of infrastructure services and/or applications. The “Availability” workload profile of column 204 includes standard performance characteristics with critical Service Level Agreements. Characteristics of this type may include IT in support of ERP (Enterprise Resource Planning, an aspect of application integration that tends to focus on business management software), or databases, for example.

A “Performance” workload profile, shown in column 206, depicts higher-performance characteristics that may be particularly useful in data-intensive or compute-intensive environments, such as one may encounter in dealing with IT in support of pharma (pharmaceutical) modeling and analytics. A “Response” workload profile, as depicted in column 208 and noted briefly above, describes an environment having fast system response characteristics given speed requirements. This type of workload profile is generally directed toward IT in support of stock market analytics, for example, or CAD (computer-aided design) with 3D real-time graphics. A “Throughput” workload profile, as shown in column 210, is suited to volume and speed characteristics required to process large quantities of data, for example, in genomics research, or in oil, coal, or gas analytics.

Representative samples of workload profiles have been described above. Of course, additional profiles may be created to address differing requirements and technology environments. These environments may include server, mainframe, and others, delivered via dedicated hardware or as IT services via cloud computing solutions.

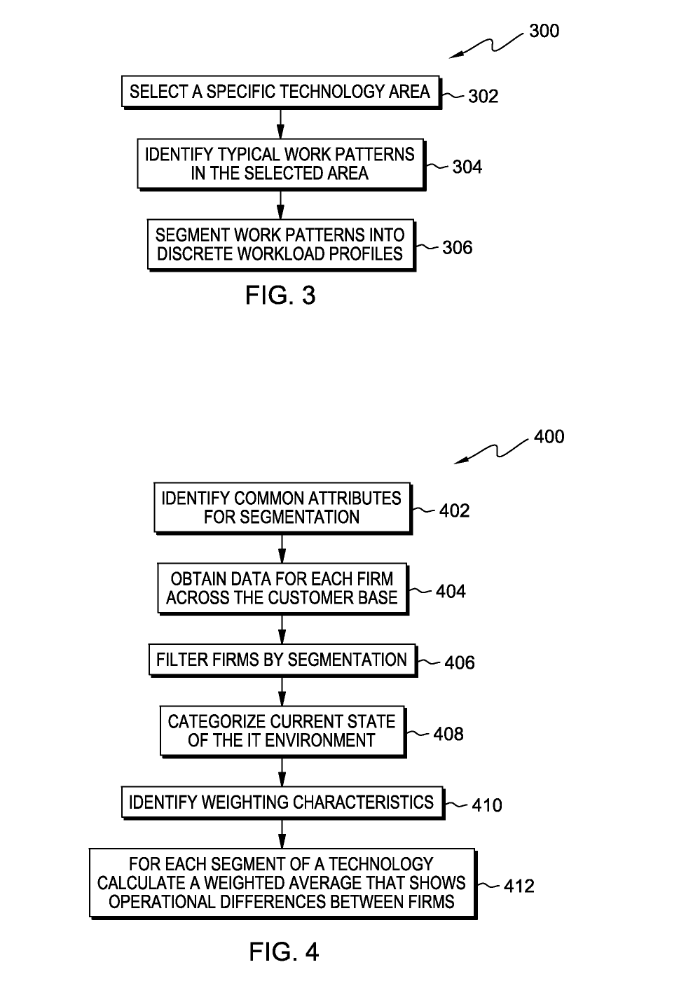

FIG. 3 is a flowchart depicting development of a workload profile in accordance with an embodiment of the present invention. Developing a workload profile begins by selecting a specific technology area (Step 302). The specific technology area may be, for example, without limitation, storage, servers, mainframe, end user support services, network operation and maintenance, among many others. This list of technology areas is illustrative in nature, and is not intended to be exhaustive. In the subsequent step (304), work patterns in the selected technology area are identified and understood. For example, discrete work patterns for the management of servers exist that represent predefined performance levels across elements such as availability, throughput, processing power, and others. In Step 306, the work patterns are made into discreet workload profiles by characterizing common attributes for each profile. These may include hardware, software, and labor support capabilities, for example. In another example, discreet infrastructure performance characteristics may be identified, such as I/O speeds, or the ratio of reads to writes.

Before addressing a customer in a specific market segment, a market-based profile is developed. Market-based profiles encapsulate common IT characteristics and requirements for firms in specific market segments, where these segments can be industry-oriented (e.g., “Banking”), sub-industry-oriented (e.g., “Regional Banking”), or other orientation in which commonality exists across a set of participants. These market-based profiles specify technical (software and hardware, for example) and operational attributes of an IT environment for a specific market segment, and are generally drawn from the service solution provider's experience across a broad customer base.

FIG. 4 is a flowchart of steps involved in creating a market-based profile in accordance with an embodiment of the present invention. In Step 402, common attributes are identified for segmentation. For example, the input/output profile across read/write demands for storage media represent characteristics that help define segmentation of profiles for the management of storage environments. Some environments, such as those found in financial firms engaged in equity and/or bond trading, require high availability of information and data, whereas other environments, such as those found in mining firms, have a lesser need for quick access to information and data. This segmentation can occur based upon industry, sub-industry, etc. For example, “banking” may be selected as the industry, and “regional banking” may be the sub-industry. In the subsequent step (404), data is obtained that is representative of the IT environments of multiple firms. Data sets containing this information are potentially quite large, and may also be stored in disparate database management systems (DBMS) where data formats are not compatible with each other. As shown in FIG. 1, relevant data may be stored on a network accessible storage device 106 on which multiple data sets 114 reside. Data may also be stored on one or more database servers 108 that are accessible through the network. Data is most easily obtained from current or previous customers as a general proposition, but publicly available data may also be imported for this purpose. The firms are then filtered by segmentation in Step 406 (FIG. 4).

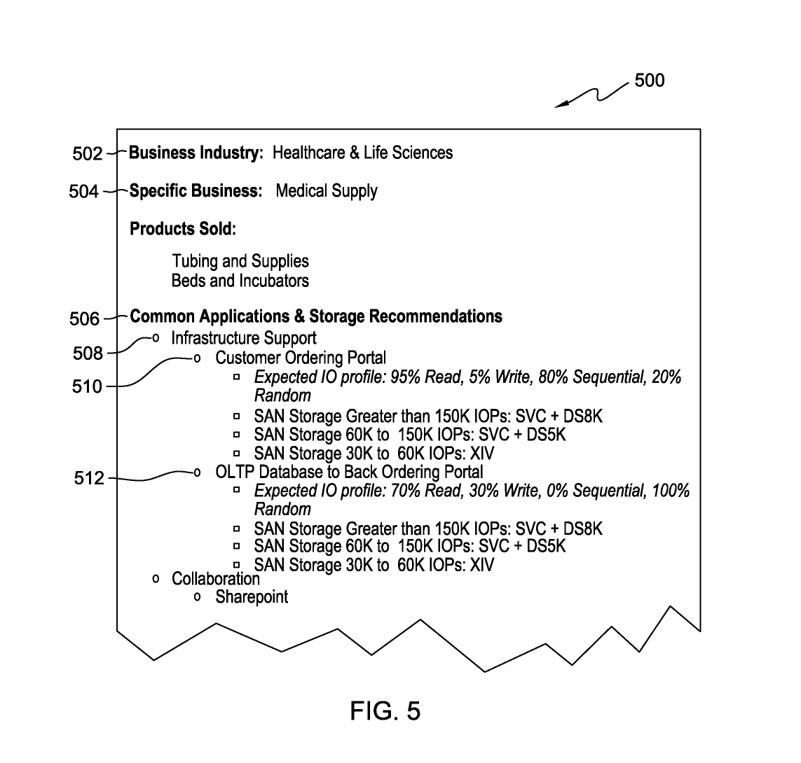

For each firm, in accordance with Step 408, the current state IT environment is categorized according to a template to capture service, hardware, and software characteristics of a specific technology domain. FIG. 5 is a representation, generally depicted by the numeral 500, of a portion of a market-based profile for storage, for the healthcare and life sciences business industry 502, in accordance with an embodiment of the present invention. The specific business 504 of the potential customer is characterized as “Medical Supply.” Common Applications & Storage Recommendations 506 are listed for this particular potential customer, with Infrastructure Support 508 prominently featured.

Storage considerations for a Customer Ordering Portal 510 are listed based upon ranges of storage requirements, listing particular hardware arrangements satisfying the listed ranges, along with an expected I/O profile for the Customer Ordering Portal 510. It is worthwhile to note that storage system performance ranges are expressed in IOPs (Input/Output Operations per second). A SAN Volume Controller (SVC) is frequently recommended, along with appropriate hardware for the desired performance level. XIV refers to a high-end cloud storage system. Storage considerations are also listed for an OLTP (Online Transaction Processing) Database to a Back Ordering Portal 512. The expected I/O profile is characterized, and recommendations are included for satisfying various ranges of storage performance.

Returning now to FIG. 4, in Step 410, desired weighting characteristics are identified to account for operational differences between customers. In a “Banking” example, a weighting factor w may be employed (e.g., Key Bank as compared to JP Morgan Chase, where JP Morgan Chase has significant operations outside of banking). Other weighting such as market share, number of customers, or breadth of operations, for example, may also be used.

In Step 412, templates describing the IT environment for each firm by segment are aggregated, calculating a weighted average for the profile values according to:

$${\overline{ξ}}^{i , j , k} = \frac{1}{N} {\sum }_{n = 1}^{N} {w}_{n}^{i , j , k} \cdot {ξ}_{n}^{i , j , k} \qquad ( 1 )$$

where i indicates the market segment (e.g., “Banking”), j indicates the domain (e.g., “Storage”), k indicates the services, hardware, and/or software characteristics (e.g., Customer Ordering Portal), ξ̅^{i,j,k} is a weighted average for the profile values of market segment i and applicable to the j technology domain and k characteristic, τₙ^{i,j,k} represents a profile value in the template for a firm n in market segment i and applicable to the j technology domain and k characteristic, wₙ^{i,j,k} represents a weighting factor in the template identified to account for operational differences between customers for a firm n in market segment i and applicable to the j technology domain and k characteristic, and N represents the number of firms in the filtered sample (e.g., number of firms in the “Banking” category).

For a particular segment i and technology domain j, equation (1) above provides an “average” for the characteristics k that articulates a firm's IT environment. For instance, for the Banking industry and Storage technology domain, a solution provider may determine the average input/output profile for a customer ordering portal that allows practitioners to have a perspective on IT environments. Furthermore, one may utilize profiles of typical client environments by industry as a foundation to provide greater detail and depth of insight earlier in discussions about potential IT improvements. It is possible for an IT solutions provider to distill collective engagement experience drawn from multiple deals, and technical expertise elevated by collaboration with groups that develop leading hardware and software systems, into industry profiles for specific technologies (i.e., industry profiles for storage, server, etc). These market-based profiles encapsulate the provider's perspective on the norm for technology environments and recommendations as to specific infrastructure. Engagement teams can use the market-based profiles as a best practice approach for providing appropriate technology solutions at an industry level, providing them with a starting point for the detailed specification of a technology platform.

Rather than applying the specific weighting reflected in equation (1) above, in various embodiments, viable characteristics that articulate a firm's IT environment may also be obtained, for example, without limitation, by employing simple averaging (a weighted average with a weighting factor of 1/N), the median value from among the characteristics, or correlation to nearest-neighbor observations.

Workload profiles may be mapped to market-based profiles, linking typical client environments in specific market segments with the characteristics that describe execution of IT services centered on IT performance objectives (i.e., agnostic to market segment). The performance and technical characteristics of a market-based profile may be reproduced by representing each market-based profile as a “mixture” of workload profiles. A mapping between workload and market-based profiles may be created through the following steps:
(i) Select the technology domain;
(ii) Select the market segment and retrieve the associated market-based profile;
(iii) Retrieve the associated workload profiles;
(iv) Map the workload profiles to the market-based profile. The following equation may be used to perform the mapping:

$${\overline{ξ}}^{i , j , k} = {\sum }_{l = 1}^{L} {\sum }_{t} {M}_{t}^{i , j , k , l} \cdot {W}_{t}^{j , l} \qquad ( 2 )$$

where Wₜ^{j,l} represents the elements t of a workload profile l for a specific technology domain j, and Mₜ^{i,j,k,l} represents the mapping factor specific to a market segment i, technology domain j, characteristics k in the market-based profile, workload profile l, and element t within the workload profile. The number of workload profiles for a specific technology domain is given by L.
(v) Create average “mapping factors” to relate workload profiles to market-based profiles for a specific technology domain and market segment. The following equation may be used to calculate the average:

$${\overline{M}}^{i , j , 1} = \frac{1}{K} \frac{1}{T} {\sum }_{k , t} {M}_{t}^{i , j , k , l} \qquad ( 3 )$$

where K represents the total number of characteristics in the market-based profile and T represents the total number of elements within the workload profile; and
(vi) Aggregate average mapping factors into a table specific for technology domain, with axes given by market segment and workload profile. For technology domain j, this table may be represented as follows, with M below representing the average calculated in equation (3) above. In other words, the “overbar” nomenclature has been removed:

TABLE II
Average Mapping Factors

| | | Market Segments | | |
|---|---|---|---|---|
| | | i = 1 | i = 2 | . . . |
| Workload profiles | I = 1 | M^{1,j,1} | M^{2,j,1} | . . . |
| | I = 2 | M^{1,j,2} | M^{2,j,2} | . . . |
| | . . . | . . . | . . . | . . . |

Within the “Storage” technology area, the IT environment for specific industries, given by market-based profiles, may be represented as mixtures of workload profiles. For instance, the linkage between workload and market-based profiles for “Storage” produces the following mapping:

TABLE III
IT Environment for Specific Industries; Storage Technology Area

| | | Industry | | |
|---|---|---|---|---|
| | | Banking | Healthcare | . . . |
| Workload Profiles | Blended | 45% | 45% | . . . |
| | Availability | 25% | 25% | . . . |
| | Performance | 10% | 15% | . . . |
| | Response | 15% | 5% | . . . |
| | Throughput | 5% | 10% | . . . |

Table III indicates that a Banking market-based profile consists of 45% blended, 25% availability, 10% performance, 15% response, and 5% throughput workload profiles.

By explicitly linking workload profiles and market-based profiles, service solutions can be created using a reduced set of parameters (i.e., market-based profiles and unique parameters not embedded directly in the profiles due to large variation in specifications), given by the client's market segment. In essence, to form the industry standard service solution, the practitioner may provide information as to 1) the client's industry, 2) high-level volume information such as number of images or GB of storage, and 3) parameters that are not natively embedded into the workload profiles.

To create an initial solution for the storage environment, a limited number of inputs are generally provided, with several variables auto-calculated but available for adjustment to suit the client's particular environment and needs. Specifically, the following fields are available for entry: industry, total GB (gigabytes) of storage, locations, and SAN (storage area network) attached servers. The following fields are then auto-calculated, with values that can be overridden to address client-unique specifications:
% GB Blended, Availability, Performance, Response, Throughput (calculated from specification of industry).
Gigabytes by Storage priority, commonly delineated in IT nomenclature as Storage “Tiers” (calculated from workload profiles). Tiers of storage, in this context, is common industry terminology that represents performance/cost of various forms of storage. Although precise definitions for the various storage tiers are elusive, Tier 1 storage is generally fast, accurate storage supported by high-speed disk systems that are often associated with premium pricing. Tier 2 storage provides adequate performance in applications where high-speed data interchange is not generally required, but large amounts of data may be involved. Tier 2 storage systems are generally available at a lower cost than Tier 1 storage systems. Tier 3 storage systems are often directed toward storage of data that are accessed infrequently, but nonetheless require reasonable availability. Tier 3 storage is generally available at a lower cost (reflecting lower performance) than the higher level storage tiers.
GB requiring replication (calculated from workload profiles).
   In addition, the following parameters that are not explicitly linked to the workload profiles may need to be specified:
US delivery only?
Service solution provider have financial responsibility for facilities costs?
HW and SW not included?
Cloud?
Software for regulatory compliance included?
Software for data management and/or legal (e.g., eDiscovery)?
Software for data security and encryption?
Energy efficient data center project included?

These parameters are specified through the following illustrative interface:

TABLE IV
Illustrative Interface
Storage Systems

| Industry | Banking |
|---|---|
| Total GB | 5,000 |
| % GB Blended | 20% |
| % GB Availability | 30% |
| % GB Performance | 15% |
| % GB Response | 25% |
| % GB Throughput | 10% |
| Tier 1 GB | 3,000 |
| Tier 2 GB | 1,000 |
| Tier 3 GB | 1,000 |
| GB requiring replication | 0 |
| Locations | 1 |
| SAN Attached Servers | 0 |
| Attributes (Apply to All Storage) | |
| US Delivery Only (No GR)-SAN | N |
| Provider has financial responsibility for facilities costs? | N |
| HW and SW Not Included | N |
| Cloud | Y |
| Software for regulatory compliance included? | N |
| Software for data management or legal (e.g., eDiscovery)? | N |
| Software for data security and encryption? | N |
| Energy-efficient data center project included? | N |

If a service solutions provider selects “Banking” for their client's industry and specifies the size of the storage environment in GB, the tool provides the distribution across workload profiles and tiers seen in Table IV above. The levels of blended, availability, performance, response, and throughput (vs. the granular details underlying the specification of hardware, software, and labor in the industry profile) are adjusted given client unique requirements, as well as the amount of storage identified as Tier 1, 2, or 3, to meet the client's specified need. As noted previously, tiered storage is the assignment of different categories of data to different types of storage media in order to match a customer's performance and cost requirements.

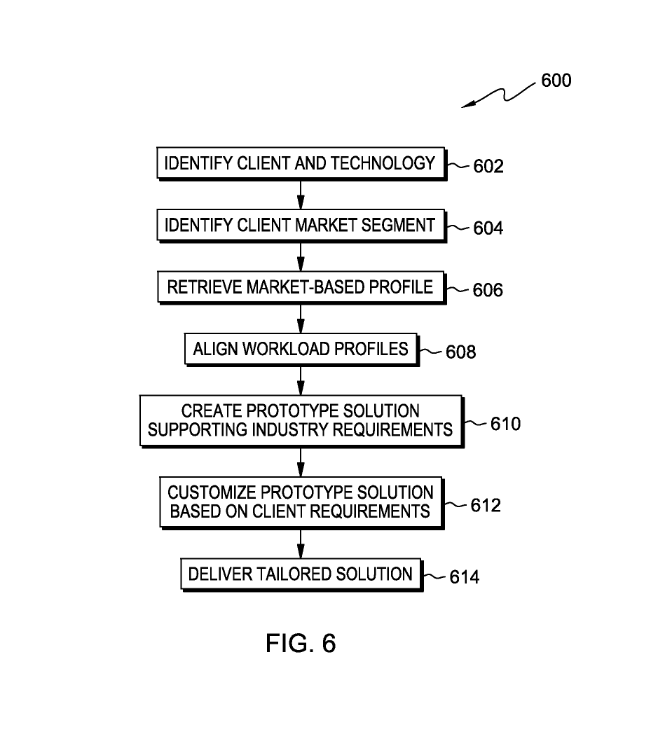

FIG. 6 is a flowchart, generally depicted by the numeral 600, of steps involved in building and tailoring a client solution in accordance with an embodiment of the present invention. To begin building the solution, the client for which the solution is being built and the applicable technology domain(s) are identified in Step 602. In the next step (604), the client market segment (industry, for example) is identified. Next, in Step 606, the appropriate market-based profile for the client is retrieved, given the pertinent market segment and technology area pertinent to the client (e.g., storage environment in the Banking industry). Of course, in the event that a market-based profile is not available for a particular client, one may be generated, wherein the market-based profile is derived, at least in part, from the identified market segment and the applicable technology domain. The newly generated market-based profile may then be stored for later retrieval. Market-based profiles are mapped to workload profiles such that, in Step 608, the applicable workload profiles are retrieved, given the market-based profile for the client. In an embodiment, applicable workload profiles describe the execution of information technology services for the client. In Step 610, a prototype solution is created based on the alignment of workload profiles to market-based profiles. This represents a prototype solution addressing common market requirements for the specific client's specific market, but does not provide a client-unique specification of parameters divergent from industry average. This is satisfied in the next step (612), where the prototype solution is customized based on specific client requirements. Using client requirements such as the size of the environment, the geographic distribution, true processing and storage needs, corporate directives, policies, rules, compliance to industry and government regulations, the solution is adjusted to address these requirements. For example, clients supporting the Canadian government must use Canadian citizens living in Canada. In Step 614, the tailored best practice solution is delivered to the client for their evaluation and further action.

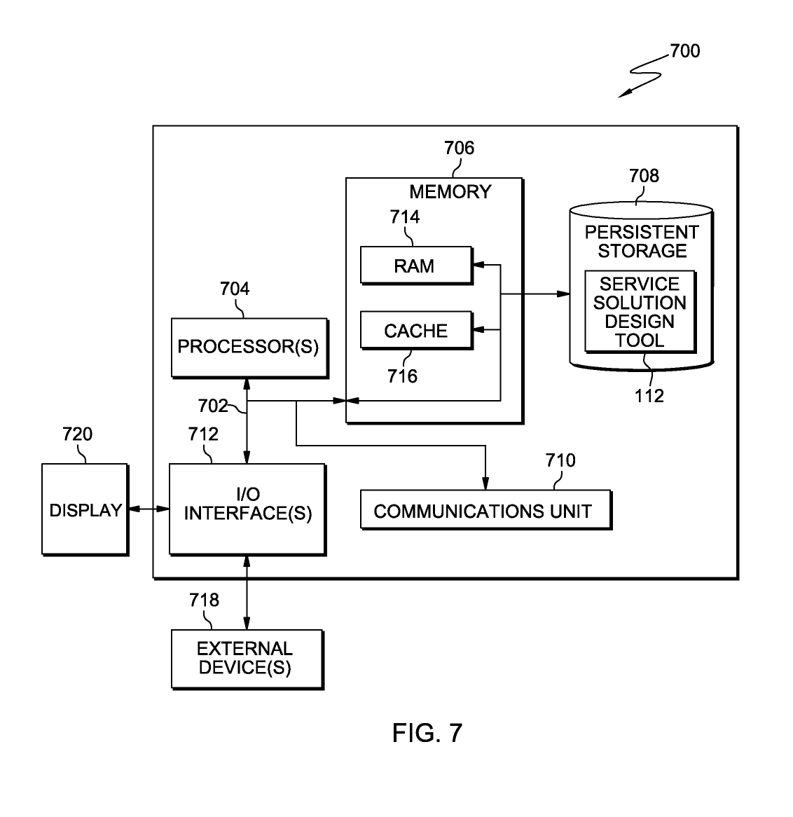

FIG. 7 is a functional block diagram of a computer system in accordance with an embodiment of the present invention. FIG. 7 depicts computer system 700, which is representative of server computer 102 that hosts service solution design tool 112 in accordance with an illustrative embodiment of the present invention. It should be appreciated that FIG. 7 provides only an illustration of one implementation and does not imply any limitations with regard to the environments in which different embodiments may be implemented. Many modifications to the depicted environment may be made.

Computer system 700 includes communications fabric 702, which provides communications between computer processor(s) 704, memory 706, persistent storage 708, communications unit 710, and input/output (I/O) interface(s) 712. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses.

Memory 706 and persistent storage 708 are examples of computer-readable tangible storage devices. A storage device is any piece of hardware that is capable of storing information, such as, data, program code in functional form, and/or other suitable information on a temporary basis and/or permanent basis. In this embodiment, memory 706 includes random access memory (RAM) 714 and cache memory 716. RAM 714 may be used to temporarily store input data such as data collected from database server 108, as well as intermediate and final results in accordance with the present invention. In general, memory 706 can include any suitable volatile or non-volatile computer-readable storage device. Software and data may be stored in persistent storage 708 for access and/or execution by processors 704 via one or more memories of memory 706. With respect to server computer 102, for example, service solution design tool 112, possible associated data structures and resources, and any requisite disk workspace may reside in persistent storage 708.

In this embodiment, persistent storage 708 includes a magnetic hard disk drive. Alternatively, or in addition to a magnetic hard disk drive, persistent storage 708 can include a solid state hard drive, a semiconductor storage device, read-only memory (ROM), erasable programmable read-only memory (EPROM), flash memory, or any other computer-readable storage devices capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer-readable storage medium that is also part of persistent storage 708.

Communications unit 710, in these examples, provides for communications with other sub-systems or devices. In an embodiment, communications unit 710 may provide appropriate interfaces to network 110 or other suitable data communications fabric to connect to client device 104, network storage device 106, and database server 108. In these examples, communications unit 710 may include one or more network interface cards. Communications unit 710 may provide communications through the use of either or both physical and wireless communications links. Software, such as service solution design tool 112 and relevant data files or databases may be downloaded to persistent storage 708 through communications unit 710.

I/O interface(s) 712 allows for input and output of data with other devices that may be connected to computer 700. For example, I/O interface 712 may provide a connection to external devices 718 such as a keyboard, keypad, a touch screen, and/or some other suitable input device. External devices 718 can also include portable computer-readable storage media such as, for example, thumb drives, portable optical or magnetic disks, and memory cards. Software, such as service solution design tool 112 and relevant data files or databases can be stored on such portable computer-readable storage media and can be loaded onto persistent storage 708 via I/O interface(s) 712. I/O interface(s) 712 also can connect to a display 720.

Display 720 provides a mechanism to display data to a user and may be, for example, a computer monitor. Display 720 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for automated design of information technology service solutions, the method comprising:
identifying, by one or more processors, a client for whom the service solution is being provided, and an applicable technology domain associated with the client;
identifying, by one or more processors, a market segment associated with the client;
generating, by one or more processors, a market-based profile for the client, the market-based profile derived, at least in part, from the identified market segment and the applicable technology domain;
retrieving, by one or more processors, applicable workload profiles for the client, wherein the applicable workload profiles are retrieved, at least in part, by mapping the generated market-based profile for the client to a plurality of workload profiles;
generating, by one or more processors, a prototype solution, based, at least in part, on alignment of the applicable workload profiles to the market-based profile for the client, wherein the prototype solution addresses common market requirements for the client's specific market; and
customizing, by one or more processors, the prototype solution, based, at least in part, upon specific client requirements, to provide a solution that includes client-unique specification of service solution parameters.

2. The method in accordance with claim 1, further comprising:
maintaining one or more databases, the databases including a plurality of workload profiles representing specifications, unrelated to a specific industry, for hardware, software, and services associated with specific performance characteristics within specific technology environments.

3. The method in accordance with claim 2, wherein the databases further include a plurality of market-based profiles that encapsulate common IT characteristics and requirements for firms in specific market segments, wherein the market-based profiles specify technical and operational attributes of an IT environment for a specific market segment.

4. The method in accordance with claim 1, wherein retrieving, by one or more processors, applicable workload profiles for the client further comprises:
selecting a specific technology area;
identifying typical work patterns within the technology area and associating the work patterns with predefined performance levels within the work patterns of the technology area; and
segmenting the work patterns into discrete workload profiles by characterizing common attributes for each profile, and identifying discreet infrastructure performance characteristics.

5. The method in accordance with claim 1, wherein generating, by one or more processors, a market-based profile for the client further comprises:
identifying common attributes for segmentation into specific market segments;
obtaining data from one or more databases representative of IT environments in firms within the market segment;
categorizing current state IT environment for each firm according to a template to capture service, hardware, and software characteristics of a specific technology domain;
identifying desired weighting characteristics to account for operational differences between firms; and
calculating a weighted average for profile values within the templates according to the relation:
$${\overline{ξ}}^{i , j , k} = \frac{1}{N} {\sum }_{n = 1}^{N} {w}_{n}^{i , j , k} \cdot {ξ}_{n}^{i , j , k}$$
where i indicates the market segment (e.g., “Banking”), j indicates the domain (e.g., “Storage”), k indicates the services, hardware, and/or software characteristics (e.g., Customer Ordering Portal), ξ̅^{i,j,k} is a weighted average for the profile values of market segment i and applicable to the j technology domain and k characteristic, ξₙ^{i,j,k} represents a profile value in the template for a firm n in market segment i and applicable to the j technology domain and k characteristic, wₙ^{i,j,k} represents a weighting factor in the template identified to account for operational differences between customers for a firm n in market segment i and applicable to the j technology domain and k characteristic, and N represents the number of firms in the filtered sample (e.g., number of firms in the “Banking” category);
such that an average for characteristics that articulate a firm's IT environment is provided.

6. The method in accordance with claim 1, wherein generating, by one or more processors, a prototype solution, based, at least in part, on alignment of the applicable workload profiles to the market-based profile for the client further comprises:
mapping the workload profiles to the market-based profile in accordance with the following relation:
$${\overline{ξ}}^{i , j , k} = {\sum }_{l = 1}^{L} {\sum }_{t} {M}_{t}^{i , j , k , l} \cdot {W}_{t}^{j , l}$$
where Wₜ^{j,l} represents the elements t of a workload profile l for a specific technology domain j, and Mₜ^{i,j,k,l} represents the mapping factor specific to a market segment i, technology domain j, characteristics k in the market-based profile, workload profile l, and element t within the workload profile, and L represents number of workload profiles for a specific technology domain;
creating average mapping factors to relate workload profiles to market-based profiles for a specific technology domain and market segment in accordance with the following relation:
$${\overline{M}}^{i , j , 1} = \frac{1}{K} \frac{1}{T} {\sum }_{k , t} {M}_{t}^{i , j , k , l}$$
where K represents total number of characteristics in the market-based profile and T represents total number of elements within the workload profile; and
aggregating average mapping factors into a table specific for technology domain, with axes given by market segment and workload profile.

7. The method in accordance with claim 6, further comprising:
explicitly linking workload profiles to market-based profiles to generate a service solution that utilizes a reduced set of parameters given by the client's market segment, including market-based profiles and unique parameters not included directly in the profiles due to specification variation.

8. The method in accordance with claim 1, wherein customizing, by one or more processors, the prototype solution further comprises:
adjusting the prototype solution to address client requirements including one or more of: size of environment, geographic distribution, actual processing and storage requirements, corporate directives, policies, rules, and compliance with industry and government regulations.

9. A computer program product for automated design of information technology service solutions, the computer program product comprising:
one or more computer readable tangible storage media and program instructions stored on at least one of the one or more storage media, the program instructions comprising:
program instructions to identify a client for whom the service solution is being provided, and an applicable technology domain associated with the client;
program instructions to identify a market segment associated with the client;
program instructions to generate a market-based profile for the client, the market-based profile derived, at least in part, from the identified market segment and the applicable technology domain;
program instructions to retrieve applicable workload profiles for the client, wherein the applicable workload profiles are retrieved, at least in part, by mapping the generated market-based profile for the client to a plurality of workload profiles;
program instructions to generate a prototype solution, based, at least in part, on alignment of the applicable workload profiles to the market-based profile for the client, wherein the prototype solution addresses common market requirements for the client's specific market; and
program instructions to customize the prototype solution, based, at least in part, upon specific client requirements, to provide a solution that includes client-unique specification of service solution parameters.

10. The computer program product of claim 9, further comprising:
program instructions to maintain one or more databases, the databases including a plurality of workload profiles representing specifications, unrelated to a specific industry, for hardware, software, and services associated with specific performance characteristics within specific technology environments.

11. The computer program product of claim 10, wherein the databases further include a plurality of market-based profiles that encapsulate common IT characteristics and requirements for firms in specific market segments, wherein the market-based profiles specify technical and operational attributes of an IT environment for a specific market segment.

12. The computer program product of claim 9, wherein program instructions to retrieve applicable workload profiles for the client further comprise:
program instructions to select a specific technology area;
program instructions to identify typical work patterns within the technology area and associating the work patterns with predefined performance levels within the work patterns of the technology area; and
program instructions to segment the work patterns into discrete workload profiles by characterizing common attributes for each profile, and identifying discreet infrastructure performance characteristics.

13. The computer program product of claim 9, wherein program instructions to generate a market-based profile for the client further comprise:
program instructions to identify common attributes for segmentation into specific market segments;
program instructions to obtain data from one or more databases representative of IT environments in firms within the market segment;
program instructions to categorize current state IT environment for each firm according to a template to capture service, hardware, and software characteristics of a specific technology domain;
program instructions to identify desired weighting characteristics to account for operational differences between firms; and
program instructions to calculate a weighted average for profile values within the templates according to the relation:
$${\overline{ξ}}^{i , j , k} = \frac{1}{N} {\sum }_{n = 1}^{N} {w}_{n}^{i , j , k} \cdot {ξ}_{n}^{i , j , k}$$
where i indicates the market segment (e.g., “Banking”), j indicates the domain (e.g., “Storage”), k indicates the services, hardware, and/or software characteristics (e.g., Customer Ordering Portal), ξ̅^{i,j,k} is a weighted average for the profile values of market segment i and applicable to the j technology domain and k characteristic, ξₙ^{i,j,k} represents a profile value in the template for a firm n in market segment i and applicable to the j technology domain and k characteristic, wₙ^{i,j,k} represents a weighting factor in the template identified to account for operational differences between customers for a firm n in market segment i and applicable to the j technology domain and k characteristic, and N represents the number of firms in the filtered sample (e.g., number of firms in the “Banking” category);
such that an average for characteristics that articulate a firm's IT environment is provided.

14. The computer program product of claim 9, wherein program instructions to generate a prototype solution, based, at least in part, on alignment of the applicable workload profiles to the market-based profile for the client further comprise:
program instructions to map the workload profiles to the market-based profile in accordance with the following relation:
$${\overline{ξ}}^{i , j , k} = {\sum }_{l = 1}^{L} {\sum }_{t} {M}_{t}^{i , j , k , l} \cdot {W}_{t}^{j , l}$$
where Wₜ^{j,l} represents the elements t of a workload profile l for a specific technology domain j, and Mₜ^{i,j,k,l} represents the mapping factor specific to a market segment i, technology domain j, characteristics k in the market-based profile, workload profile l, and element t within the workload profile, and L represents number of workload profiles for a specific technology domain;
program instructions to create average mapping factors to relate workload profiles to market-based profiles for a specific technology domain and market segment in accordance with the following relation:
$${\overline{M}}^{i , j , 1} = \frac{1}{K} \frac{1}{T} {\sum }_{k , t} {M}_{t}^{i , j , k , l}$$
where K represents total number of characteristics in the market-based profile and T represents total number of elements within the workload profile; and
program instructions to aggregate average mapping factors into a table specific for technology domain, with axes given by market segment and workload profile.

15. The computer program product of claim 14, further comprising:
program instructions to explicitly link workload profiles to market-based profiles to generate a service solution that utilizes a reduced set of parameters given by the client's market segment, including market-based profiles and unique parameters not included directly in the profiles due to specification variation.

16. The computer program product of claim 9, wherein program instructions to customize the prototype solution further comprise:
program instructions to adjust the prototype solution to address client requirements including one or more of: size of environment, geographic distribution, actual processing and storage requirements, corporate directives, policies, rules, and compliance with industry and government regulations.

17. A computer system for automated design of information technology service solutions, the computer system comprising:
one or more computer processors;
one or more computer readable storage media; and
program instructions stored on the computer readable storage media for execution by at least one of the one or more computer processors, the program instructions comprising:
program instructions to identify a client for whom the service solution is being provided, and an applicable technology domain associated with the client;
program instructions to identify a market segment associated with the client;
program instructions to generate a market-based profile for the client, the market-based profile derived, at least in part, from the identified market segment and the applicable technology domain;
program instructions to retrieve applicable workload profiles for the client, wherein the applicable workload profiles are retrieved, at least in part, by mapping the generated market-based profile for the client to a plurality of workload profiles;
program instructions to generate a prototype solution, based, at least in part, on alignment of the applicable workload profiles to the market-based profile for the client, wherein the prototype solution addresses common market requirements for the client's specific market; and
program instructions to customize the prototype solution, based, at least in part, upon specific client requirements, to provide a solution that includes client-unique specification of service solution parameters.

18. The computer system of claim 17, wherein program instructions to retrieve applicable workload profiles for the client further comprise:
program instructions to select a specific technology area;
program instructions to identify typical work patterns within the technology area and associating the work patterns with predefined performance levels within the work patterns of the technology area; and
program instructions to segment the work patterns into discrete workload profiles by characterizing common attributes for each profile, and identifying discreet infrastructure performance characteristics.

19. The computer system of claim 17, wherein program instructions to generate a market-based profile for the client further comprise:
program instructions to identify common attributes for segmentation into specific market segments;
program instructions to obtain data from one or more databases representative of IT environments in firms within the market segment;
program instructions to categorize current state IT environment for each firm according to a template to capture service, hardware, and software characteristics of a specific technology domain;
program instructions to identify desired weighting characteristics to account for operational differences between firms; and
program instructions to calculate a weighted average for profile values within the templates according to the relation:
$${\overline{ξ}}^{i , j , k} = \frac{1}{N} {\sum }_{n = 1}^{N} {w}_{n}^{i , j , k} \cdot {ξ}_{n}^{i , j , k}$$
where i indicates the market segment (e.g., “Banking”), j indicates the domain (e.g., “Storage”), k indicates the services, hardware, and/or software characteristics (e.g., Customer Ordering Portal), ξ̅^{i,j,k} is a weighted average for the profile values of market segment i and applicable to the j technology domain and k characteristic, ξₙ^{i,j,k} represents a profile value in the template for a firm n in market segment i and applicable to the j technology domain and k characteristic, wₙ^{i,j,k} represents a weighting factor in the template identified to account for operational differences between customers for a firm n in market segment i and applicable to the j technology domain and k characteristic, and N represents the number of firms in the filtered sample (e.g., number of firms in the “Banking” category);
such that an average for characteristics that articulate a firm's IT environment is provided.

20. The computer system of claim 17, wherein program instructions to generate a prototype solution, based, at least in part, on alignment of the applicable workload profiles to the market-based profile for the client further comprise:
program instructions to map the workload profiles to the market-based profile in accordance with the following relation:
$${\overline{ξ}}^{i , j , k} = {\sum }_{l = 1}^{L} {\sum }_{t} {M}_{t}^{i , j , k , l} \cdot {W}_{t}^{j , l}$$
where Wₜ^{j,l} represents the elements t of a workload profile l for a specific technology domain j, and Mₜ^{i,j,k,l} represents the mapping factor specific to a market segment i, technology domain j, characteristics k in the market-based profile, workload profile l, and element t within the workload profile, and L represents number of workload profiles for a specific technology domain;
program instructions to create average mapping factors to relate workload profiles to market-based profiles for a specific technology domain and market segment in accordance with the following relation:
$${\overline{M}}^{i , j , 1} = \frac{1}{K} \frac{1}{T} {\sum }_{k , t} {M}_{t}^{i , j , k , l}$$
where K represents total number of characteristics in the market-based profile and T represents total number of elements within the workload profile; and
program instructions to aggregate average mapping factors into a table specific for technology domain, with axes given by market segment and workload profile.
